(19) United States
(12) Patent Application Publication
(10) Pub. No.: US 2025/0110704 A1
(43) Pub. Date: Apr. 3, 2025

(54) AUTOMATED SCRIPT GENERATOR

(71) Applicant: DISH Wireless L.L.C., Littleton, CO (US)

(72) Inventor: Velmurugan Manoharan, Commerce City, CO (US)

(21) Appl. No.: 18/479,655

(22) Filed: Oct. 2, 2023

(51) Int. Cl. G06F 8/30

(52) U.S. Cl. CPC G06F 8/31

(57) ABSTRACT

Devices, systems, and methods for automated generation of script in a software development environment are provided. An example method includes receiving a request for a script from the user, the request indicating a scripting language type and including input data and information related to the script. The method further includes analyzing the information related to the script to determine one or more attributes related to the script and identifying a standardized script template for the requested script. The standardized script template is stored in a database in connection with the automated script generator and has the requested scripting language type and attributes that match the determined attributes of the script. The method further includes configuring the standardized script template with the input data included in the request, generating a script based on the configuration of the standardized script template, and executing an audit function on the generated script.

### BACKGROUND

In a dynamic and diversified software development environment, where multiple specialized software development teams collaborate on various aspects of a software development project, the complexity of scripting and coding languages used can often pose significant challenges. For example, each team may tend to focus on specific tools and languages tailored to their domain and thereby diversifying scripts in a software or service product pipeline. This diversification, while possibly enhancing expertise in particular areas, may also lead to an intricate landscape of scripting requirements. The consequence of this specialization is that software developers may not possess mastery over all the tools and scripting languages utilized across different teams. Accordingly, the process of generating scripts can become not only time-consuming but also highly inefficient, especially for new developers who are not well-versed in these diverse language tools.

### SUMMARY

In accordance with some embodiments of the present disclosure, a method is provided. The method may be a computer-implemented method performed by an automated script generator in communication with a user. In one example, the method includes receiving, in the automated script generator, a request for a script from the user, and the request indicates a scripting language type and including input data and information related to the script. The method further includes analyzing the information related to the script to determine one or more attributes related to the script. The method further includes identifying a standardized script template for the requested script. The standardized script template may be stored in a database in connection with the automated script generator and has the requested scripting language type and attributes that match the determined attributes of the script. The method further includes configuring the standardized script template with the input data included in the request, generating a script based on the configuration of the standardized script template, and executing an audit function on the generated script.

In accordance with some embodiments of the present disclosure, automated script generator is provided. The automated script generator may include a computer system that further includes computer hardware and software that form special-purpose network circuitry to implement various embodiments according to the present disclosure. In one example, the automated script generator includes one or more processors and a computer-readable storage media storing computer-executable instructions. The computer-executable instructions, when executed by the one or more processors, cause the automated script generator to: receive, in the automated script generator, a request for a script from a user. The request indicates a scripting language type and including input data and information related to the script. The computer-executable instructions, when executed by the one or more processors, may further cause the automated script generator to analyze the information related to the script to determine one or more attributes related to the script and identify a standardized script template for the requested script. The standardized script template may be stored in a database in connection with the automated script generator and has the requested scripting language type and attributes that match the determined attributes of the script. The computer-executable instructions, when executed by the one or more processors, may further cause the automated script generator to configure the standardized script template with the input data included in the request, generate a script based on the configuration of the standardized script template, and execute an audit function on the generated script. In another example, the automated script generator is implemented as a cloud-based service.

In accordance with some embodiments, the present disclosure also provides a non-transitory machine-readable storage medium encoded with instructions, the instructions executable to cause one or more electronic processors of an automated script generator to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic diagram illustrating an example of a communications system according to various embodiments.

FIG. 2 is a flow diagram illustrating an example method according to various embodiments.

FIG. 3 is a flow diagram illustrating an example method according to various embodiments.

FIG. 4 is a schematic diagram illustrating an example computer system or computer device, according to various embodiments.

### DETAILED DESCRIPTION

The present disclosure provides devices, systems, and methods for the automated generation of scripts within a software development environment. According to some embodiments, an automated script generator and a streamlined and automated process can be employed to promptly create a new script in response to a developer's request. This streamlined process may include several steps: first, the establishment of a library/inventory/repository comprising standardized module templates and script templates; next, the identification of the module templates and script templates which align with the attributes specified for the new script by the requesting developer; followed by the generation of the new script, drawing from the identified module templates and script templates as well as incorporating the developer's input; subsequently, an audit function is executed to validate and test the newly generated script; and ultimately, access is granted to the requesting developer, providing them with the new script.

The process can significantly accelerate script creation by leveraging standardized module templates and script templates, reducing the time and effort required for developers to write scripts from scratch, and reducing the learning curve for scripting languages. Standardized module templates and script templates may also improve code consistency and reduce error rates. Various development teams of business units across different development stages and language domains can collaborate effectively, as the process bridges language and expertise gaps.

Moreover, as compared with open-sourced script generation techniques, the automated script generator according to the present disclosure can be tailored to the specific needs and requirements of the software development environment to allow for the generation of scripts that are specific and highly customized to the organization's processes and tools. This level of customization and standardization allows organizations to fine-tune the generated scripts to match their exact specifications and meet specific project requirements. Scripts generated by the automated generator can be designed to align with the organization's development processes and increase workflow efficiency.

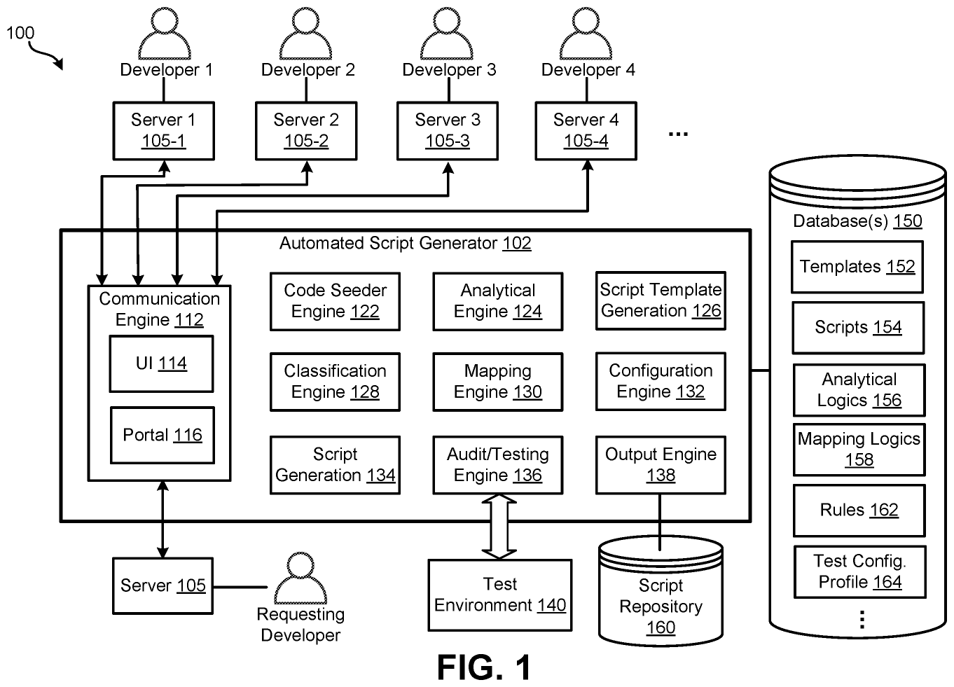

FIG. 1 is a schematic diagram illustrating an example of a communications system 100 (hereinafter “system 100”). System 100 can emulate a software development environment of an enterprise or an organization. System 100 includes, among other components, an automated script generator 102, multiple servers 105 (e.g., 105-1, 105-2, 105-3, 105-4, etc.), one or more test environments 140, one or more databases 150, and a script repository 160. System 100 as illustrated in FIG. 1 represents a component-level view. Each component of system 100 may be either a hardware entity, a software module, or a hybrid amalgamation of both. It should be noted that, in certain implementations, the components of system 100 may manifest as specialized software executed on versatile general-purpose hardware. Furthermore, to cater to specific functional requirements, system 100 may be implemented within a cloud infrastructure. For instance, the automated script generator 102 could operate as a cloud-based service.

At a high level, the automated script generator 102 (hereinafter generator 102) is responsible for performing automated generation of scripts for a software product, a service, or an application. Generator 102 can communicate with developers through the servers 105 in communication with the generator 102. Generator 102 can receive requests, inputs, and information from users (also referred to and used interchangeably with “developers”) and subsequently produce scripts based on predefined standardized templates using preestablished logics.

Servers 105 are operated by various developers (e.g., developers 1, 2, 3, 4, etc. illustrated in FIG. 1). The developers use the servers 105 for diverse purposes within the software development environment, such as programing, generating scripts, hosting applications, databases, and other pivotal services. It is noted that the developers may work in different teams within the software development environment and focus on different stages of a software development pipeline within the software development environment. For example, developer 1 may be in a user interface (UI) development team and uses specific scripting languages, such as JAVA, Angular, NodeJS, etc. Developer 2 may be in a device programing team and uses specific scripting languages such as C++, Python, Go/Shell, etc. Developer 3 may be in a data processing team and uses specific scripting languages such as Spark, Kafka, and Redshift/SQL, and developer 4 may be in an infrastructure management team and employs scripting languages such as Jenkins, Terraform, CDK, etc. Accordingly, the scripts generated by each developer may be in various scripting language types.

The server 105 may transmit scripts generated by the developers to the generator 102, and the generator 102 may receive the scripts, analyze the scripts, use scripts to create standard module script templates, classify the scripts and script templates based on various attributes such as scripting language type, service type, application type, business type, etc., and establish a library/inventory/repository of module and script templates.

When a new user (e.g., a new developer as shown in FIG. 1) boards on the software development environment, the new developer can access generator 102 through a server 105 to request the automated generation of a new script. The new developer may initiate the process by submitting an access request, specifying requirements for the new script. This may include selecting the desired scripting language type, selecting a standardized script template, selecting one or more attributes such as service type, business type, development stage, etc., and providing relevant information, input data, and data sources related to the new script. Generator 102 then analyzes the request, generates the new script, performs an audit function (i.e., validation and testing) based on predetermined rules, and delivers the new script to the new developer. This streamlined process enables developers to obtain new scripts efficiently without the need to master the specific scripting language type.

Detailed description of each component of the system 100 will be provided below. As shown in FIG. 1, generator 102 may further include, among other components, a communication engine 112, a code seeder engine 122, an analytical engine 124, a script template generation engine 126, a classification engine 128, a mapping engine 130, a configuration engine 132, a script generation engine 134, an audit engine 136 (also referred to as a testing engine 136), and an output engine 138. Additional components may also be included in generator 102 as needed for specific functionalities. In some embodiments, the components in generator 102 may work collaboratively or be combined to perform certain functions.

The communication engine 112 is responsible for facilitating communication between the generator 102 and the developers, receiving scripts from the developers, receiving requests for access and/or new scripts from developers, and transmitting generated scripts, reports, notification, and other information to the developers. In some embodiments, the communication engine 112 further includes a user interface (UI) 114 and a portal 116. The UI 114 may be a graphic UI (GUI) that services as a front-end interface for developers to interact with the generator 102. Developers can use UI 114 to submit requests, access generated scripts, and manage their interactions with generator 102. The portal 116 may serve as a central access point for developers or administrator to initiate various interactions with the generator 102. The portal 116 may provide a comprehensive platform for developers to access resources (e.g., script template, standard code section, output script, etc.), configure script parameters, and view/download generated scripts. In some implementations, the UI 114 and portal 116 may be integrated to create a unified and seamless user experience. Developers access the portal 116 as the starting point, which provides them with a gateway to various services, applications, or information sources. The portal 116 may include a customizable dashboard or homepage where developers can arrange and access specific widgets, shortcuts, or links to different services or features. Within the portal 116, there may be embedded components of UI 114 or modules that represent individual applications or services. The UI components allow developers to interact directly with specific functionalities. Developers can navigate between different services or sections within the portal 116 to operate the integrated UI components. In some embodiments, the integration of UI 114 and portal 116 may implement single sign-on (SSO) mechanisms, allowing the developer to log in once and access multiple services without repeated authentication. The servers 105 are interconnected with the communication engine 112 via a communications network established within the software development environment. The communications network, which may include a local area network (LAN) or other suitable networking infrastructure, facilitates communication and data exchange between the servers 105 and the communication engine 112.

The code seeder engine 122 is responsible for at least the following functions including receiving various inputs from developers within the software development environment, populating module templates, standardizing the module templates, managing versions of the seeded module templates, among other functions. The various inputs may include scripts, specification data, source files, variables, configuration parameters, and other relevant information related to script generation. Scripts may include code snippets or entire scripts written by developers. Specification data may include detailed specifications or requirements for the script or application. Source files may include existing source code files or components to be integrated. Variables may be specific variables or data elements required for customization. Configuration parameters may include parameters that configure the behavior of the code or application. The inputs are generated by developers in software product development pipelines. The inputs may be transmitted to the generator 102 by the servers 105.

The code seeder engine 122 may take the inputs received from developers and uses them to populate standardized module templates. In some embodiments, the code seeder engine 122 may collect scripts from different developers within the software development environment. These scripts may vary in terms of coding style, structure, and content. The code seeder engine 122 may analyze the collected scripts to determine one or more scripting language types of a received script and categorize scripts based on the language they are written in, such as JavaScript, Python, Java, etc. The code seeder engine 122 may also determine one or more service type or application type related to the script. This categorization helps understand the context and purpose of the scripts, whether they are related to user interfaces, data processing, infrastructure management, or other functionalities. The code seeder engine 122 may also identify common patterns, functions, or components that can be standardized and extract reusable elements from the script.

In some embodiments, the code seeder engine 122 may extract one or more attributes to a script or a software product to which the script is associated with. Example attributes include but are not limited to software category, application category, development stage, project complexity, technology stack, target platform, data source, performance goals, UI framework, integration points, deployment environment, documentation standards, release cycle, among others. These attributes may be relied on to classify the module templates, script templates, and the scripts within the software development environment. These extracted attributes may be used to organize and categorize the templates and scripts efficiently.

The code seeder engine 122 may create a standardized module template based on the extracted attributes and patterns. The module template is a predefined and standardized structure for a specific module used within a script for a software program. The module template may serve as a common foundation for script generation. The code seeder engine 122 may follow predetermined coding rules or guidelines to ensure that the created module template adheres to coding standards, best practices, and project-specific requirements. Further, the code seeder engine 122 may apply formatting, naming conventions, and documentation standards according to predetermined standards. The code seeder engine 122 may manage different versions of the standardized module template, allowing for updates and improvements over time. The generated standardized module template can include placeholders or variables that can be customized with specific data, variables, configurations, or input data provided by developers. The standardized module template can be used as a starting point for script generation.

The analytical engine 124 may operate in collaboration with the code seeder engine 122 and be responsible for analyzing the inputs received from the developers and facilitating the analysis of the inputs to extract reusable elements from the scripts. In some embodiments, the analytical engine 124 may employ an artificial intelligence (AI) or machine learning (ML) model to enhance the analysis. In one example, the analytical engine 124 may collect a diverse dataset of developer scripts written in different scripting languages and for various purposes within the software development environment. This dataset may serve as the training data for a ML model. the analytical engine 124 may preprocess the collected scripts by cleaning and formatting to obtain uniformity of the collected scripts. In some embodiments, the analytical engine 124 may tokenize the scripts into smaller code segments (e.g., functions, methods, statements). The analytical engine may engineer features of the scripts by extracting code snippets, identifying function/method definitions, and capturing code patterns. In some embodiments, the analytical engine 124 may choose an appropriate ML model for script analysis and element extraction. Examples of the ML model may include natural language processing (NLP) model, recurrent neural networks (RNNs), transformer models, etc. for code understanding. The analytical engine 124 may train the ML model on the preprocessed script dataset to allow the model to learn to recognize patterns, functions, and common code elements within the scripts. The analytical engine 124 may evaluate the trained ML model's performance using validation data. Metrics like precision, recall, and F1-score may be used to assess the ML model's ability to identify code elements. The analytical engine 124 may establish a feedback loop with the code seeder engine 122 to providing insights and recommendations based on the ML analysis.

The script template generator 126 is responsible for generating standardized script templates based on the standardized module templates. The script template generation engine 126 may classify the standardized module templates according to one or more attributes of the module templates such as the scripting language type, service or application type, business unit type, among others. Based on predetermined rules or guidelines of script standardization, the script template generation engine 126 may select one or more module templates that are suitable for a given script generation task to ensure that the chosen templates align with the specific requirements and objectives of the script. Once the appropriate module templates are selected, the engine combines these module templates to form a standardized script template. This combination process may involve merging code segments, functions, or components from different module templates to create a comprehensive script template as a foundation for a to-be-generated script. The standardized script template may include placeholders that allow customization with specific data, variables, configurations, or inputs provided by the developer to tailor the script to their specific needs.

The classification engine 128 is responsible for the classification of both standardized module templates and script templates within the software development environment. The classification engine 128 may categorize standardized module templates and script templates into multiple classes or categories based on various common attributes extracted from the scripts. For example, the classification engine 128 may assigning templates to specific language categories (e.g., Python, Java, JavaScript, etc.), group templates based on their intended functionality or purpose (e.g., UI, data processing, infrastructure, etc.), identify the stage of the product development pipeline to which a template is relevant (e.g., development, testing, deployment), associate templates with specific business units or departments within the organization.

As mentioned above, these attributes may include scripting language type, service/application type, business unit, development stage, project complexity, technology stack, target platform, data source, performance goals, UI framework, integration points, deployment environment, documentation standards, release cycle, among others. For example, scripts and templates can be classified based on the development stage, allowing developers to access resources that are relevant to their current phase (e.g., development, testing, production). In some embodiments, module and script templates can be tagged with the technology stack attributes for developers to choose templates compatible with the chosen stack. In some embodiments, module and script templates may be classified and separated for different deployment environments (e.g., on-premises, cloud, testing, production, etc.) based on compatibility.

The classification engine 128 may assign a unique identifier (ID) to each template to distinguish it from others in the template library or repository. These template IDs are used for efficient template retrieval and management. For enhanced categorization, the classification engine 128 may assign one or more class IDs to each template. These class IDs serve as labels or tags that indicate the template's attributes and classification, such as language type, service type, development stage, or business unit. The classification information, including unique IDs and class IDs, can be stored in the database 150 for easy access and retrieval by other components within the system 100. Developers and other components of system 100 can query the database 150 using class IDs to retrieve templates that match specific criteria or requirements.

The mapping engine 130 is responsible for identifying a standardized module template or a standardized script template that matches desired attributes of a to-be-generated new script requested by a developer. Upon receiving a request for a new script from a developer, the mapping engine 130 may analyze the desired attributes provided by a developer (e.g., included in the request and inputs from the developer) for the new script, determine the relevant attributes of the new script requested by the developer, and identify one or more standardized module templates having attributes that match the determined attributes of the requested new script. In some embodiments, the mapping engine 130 may identify a standardized script template having attributes that match the determined attributes of the requested new script.

In some embodiments, the mapping engine 130 can perform semantic analysis to understand the developer's request contextually and identify templates that not only match attributes but also align with the developer's intent. The mapping engine 130 can dynamically compose new templates by merging code segments from multiple existing module templates and create templates that are tailored precisely to the developer's request.

In some embodiments, a requesting developer (i.e., a developer requesting a new script) may select a specific module template in the UI 114, and the mapping engine 130 may identify one or more standardized module templates or script template based on the developer's selection and provide developer with the identified templates in the UI 114.

The configuration engine 132 is responsible for the configuration of variables and parameters within module templates and/or script templates based on input provided by developers. Upon receiving a request for a new script or module template from a requesting developer, the configuration engine 132 may analyze the input provided by the developer such as specific data, variables, configurations, and other customization requirements. The configuration engine 132 may identify placeholders or variables within the selected template(s) that require configuration. These placeholders may serve as markers for where developer-provided information will be integrated. Based on the identified placeholders and the developer's input, the configuration engine 132 may map specific data to each placeholder, such that the correct data or configurations are applied to the corresponding sections of the module or script template. The configuration engine 132 may dynamically populate the placeholders in the selected template(s) with the provided data, variables, and configurations. This process transforms the template into a customized script or code snippet. As part of the configuration process, the configuration engine 132 may perform data validation checks to ensure that the provided input aligns with the expected data types, formats, and constraints defined by the template. The configuration engine 132 may further integrate the configured module or script template into the developer's project environment for further development, testing, or deployment.

The script generation engine 134 is responsible for generating the new script requested by the requesting developer. In some embodiments, the script generation engine 134 may integrate the selected and configured template(s) into the script generation process. Based on the integrated template(s) and the provided input data, variables, and configurations, the script generation engine 134 may dynamically compose the new script by combining template sections with developer-provided content. The chosen generation engine 134 may promote modularity and reusability by structuring the script into manageable components or functions.

The audit engine 136 is responsible for performing/executing an audit function on the generated new script. In some embodiments, the audit function may include validation of the new script and subsequently testing the validated new script in one or more test environments. The audit engine 136 may conduct a syntax validation of the generated new script, for example, by checking for correct syntax, formatting, adherence to coding standards specific to the chosen scripting language, coherence of the different code sections (i.e., configured module templates), integrity and compatibility, and so on. In a continuous integration and continuous development (CI/CD) environment, the audit engine 136 may integrate syntax validation into the CI/CD pipeline to ensure that code quality checks are performed at each stage of development.

The audit engine 136 may further perform a testing task on the new script. In some embodiments, the audit engine 136 may identify, select, and retrieve one or more test configuration profile stored in the database, configure one or more test environments for the new script, and perform one or more testing tasks on the new script in the one or more test environments. The testing configuration profiles may contain predefined settings, test scenarios, and configurations tailored for specific types of scripts or applications. The test environments may replicate/simulate the target deployment environments to ensure realistic testing. The audit engine 136 may prepare test data, mock data, or sample inputs required for testing. The audit engine 136 may perform the testing task by executing the selected testing scenarios on the new script within the configured test environments and monitoring the performance outcome of the script, interactions, and responses to various inputs and conditions.

In one example, the audit engine may automatically perform a testing task on a validated new script. The new script may be a script module of a software product during development phase. The task is configured to test for correctness and functionality within the software product. The testing task may be initiated by preparing a dedicated testing environment that mimics the runtime conditions of the software product and configuring the testing environment or using a testing server. In some embodiments, the testing server may be a virtual machine created in a cloud server. The testing task may further include creating or collecting test data, input values, and test cases that cover various scenarios including normal and edge cases. Individual test cases may be defined by specifying the inputs, expected outputs, and any assertions or criteria for success (e.g., exceeding a predetermined threshold level of performance outcome). The test task may further include executing the testing task using automated testing frameworks to automate test case execution. Automated tests may be created in test scripts that call the script module being tested. A performance evaluation step may be included in the testing task to check the test cases and verify that the actual performance outcome matches the expected performance outcome. In some embodiments, a matching score may be generated based on a predetermined rule. A threshold performance outcome score may be determined as an indication of whether the script passes or fails the testing. The threshold performance outcome score is typically based on acceptable levels of performance and functionality. For example, a performance outcome score that exceeds the threshold score indicates that the new script passes the testing. On the other hand, a matching score that is below the threshold score indicates that the new script fails the testing, and that further modification of the new script may be needed. In some embodiments, the audit engine 136 may generate an audit report for the validation and testing. The audit report may provide insights into the validation and testing process, including pass/fail outcomes, performance metrics, and any issues or discrepancies encountered during validation and testing. The new script that passes the performance testing may be stored in the script repository 160 and provided to the requesting developer for the developer to view and access.

The output engine 138 is responsible for providing various outputs, including the new script, the standardized module and script templates utilized in script generation, the audit report, the validation report, and other pertinent information associated with the new script. The output engine 138 can make the new script and its associated data available for the developer to access and use.

The database(s) 150 may include various data received in and generated by the automated script generator 102. The database(s) 150 may include templates 152, scripts 154, analytical logics 156, mapping logics 158, rules 162, and test configuration profile 164, among others. The templates 152 may include standardized module template and script template described herein. The scripts 154 may include scripts written by and received in the generator 102, new scripts generated by the generator 102, script ID, class ID, etc. The analytical logics 156 may include various predetermined analytical models (e.g., ML models) that can be used by the analytical engine 124 to analyze the scripts, extract features from the scripts, and classify the scripts and templates. The mapping logics 158 may include predetermined matching rules used by the mapping engine to identify the templates for the generation of new scripts. The rules 162 may include standardization rules (e.g., coding guidelines and best practice guidelines, etc.) for the standardization of module templates and script templates.

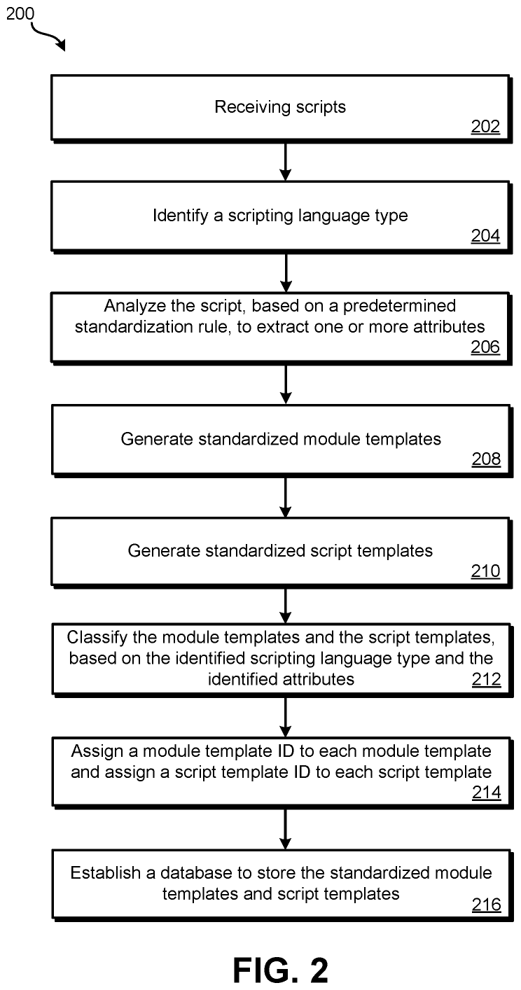

FIG. 2 is a flow diagram illustrating an example method 200 according to various embodiments. Method 200 may be performed by system 100 or any components thereof such as the automated script generator 102, as described above. Depending on the implementation, method 200 may include additional, fewer, or alternative steps performed in various orders or in parallel. Method 200 or any operations thereof may be combined with other methods described herein in any suitable manner.

At 202, scripts are received in an automated script generator. The scripts may be written or generated by developers of a software development environment. The scripts may be used by the automated script generator to generate standardized module templates and script templates and establish a template library or database for the automated generation of new scripts.

At 204, a scripting language type of each one of the received scripts is identified or determined by the automated script generator. At 206, the scripts are analyzed by the automated script generator, based on a predetermined code standardization rule, to extract one or more common attributes of the scripts.

At 208, standardized module templates are generated by the automated script generator. The standardized module templates are generated using the extracted attributes according to predetermined coding rules or guidelines. The generated standardized module template can include placeholders, variables, configuration parameters that can be customized with specific data, variables, configurations, or inputs provided by developers. In some embodiments, a ML model may be developed and used to analyze the scripts, extract attributes, and generate standardized module templates.

At 210, standardized script module templates are generated by the automated script generator. In some embodiments, one or more module templates that are suitable for a given script generation task and align with the specific requirements and objectives of the script may be identified. In some embodiments, the one or more module templates may share the same attributes, for example, scripting language type, service type, application type, business unit, development stage, etc. The identified module templates may be combined and integrated to form the standardized script template. In some embodiments, code segments, functions, and/or components from the identified module templates may be merged to create the standardized script template as a foundation for a to-be-generated script. The standardized script template may also include placeholders that allow customization with specific data, variables, configurations, or inputs provided by the developer to tailor the script to their specific needs.

At 212, the standardized module templates and script templates are classified into multiple classes or categories by the automated script generator, based on various common attributes extracted from the scripts. In some embodiments, attributes that will be used for classification are identified. These attributes can include scripting language type, service/application type, development stage, business unit/domain, complexity level, technology stack, target platform, data source, and any other relevant factors. For each module or script template, values are assigned to the identified attributes. The values are used to describe the template's characteristics. For example, a JavaScript module template may have attributes like “Scripting Language Type: JavaScript,” “Service/Application Type: Web Development,” and so on. Based on the attributes and the values thereof, categories or classes that reflect common groupings are created. Each category represents a unique combination of attribute values. In some embodiments, a hierarchical structure may be created with broader categories encompass subcategories within a category. Each template may be mapped to one or more categories based on its attribute values. A single template can belong to multiple categories. In some embodiments, the classification may be integrated into the UI to facilitate easy template selection by a developer.

At 214, a module template ID is assigned to each module template, and a script template ID is assigned to each script template. In some embodiments, unique IDs for both module templates and script templates are generated. The template ID should be associated with the specific template and serve as a reference for easy retrieval. Each template's associated ID is documented along with its attributes in a documentation of an ID library or inventory. A catalog or database that maps the IDs to the template names, attributes, and file locations may be created. In some embodiments, the assigned template IDs may be incorporated in a database as a part of the database schema.

At 216, a database is established to store the standardized module templates and script templates. In some embodiments, an appropriate database management system (DBMS) that aligns with the requirements of the software development environment may be identified and selected. A database schema may be designed to accommodate the storage needs of both module templates and script templates. Data tables, fields, and relationships to represent various templates and their attributes may be defined. Separate data tables for module templates and script templates within the database may be generated. In some embodiments, each data table may have columns to capture relevant information such as template IDs, attributes, file paths, and content. The attributes of templates are mapped to corresponding fields in the database tables to facilitate retrieval and querying. The assigned module template IDs and script template IDs may be incorporated as primary keys in their respective tables. Metadata fields may be included in the data table to capture additional information about each template, such as the creator, creation date, modification history, and usage history.

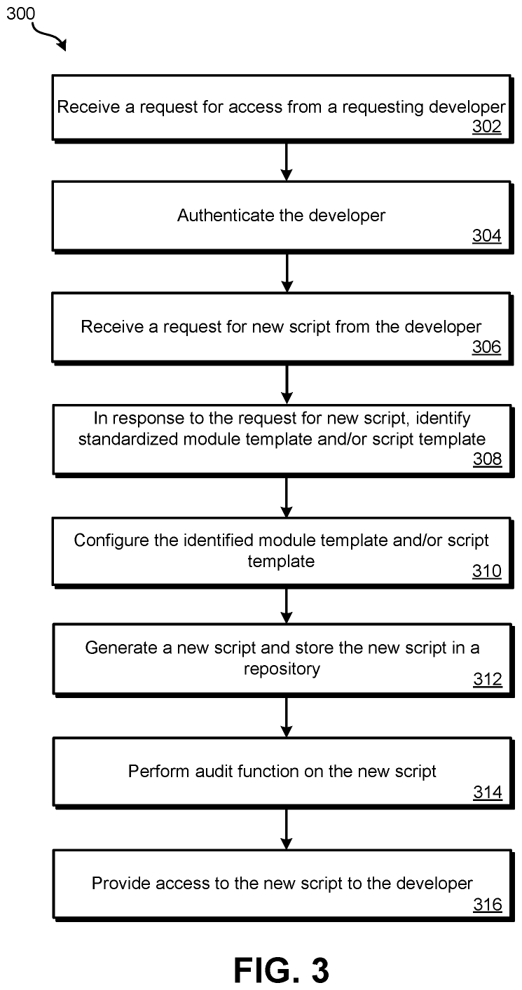

FIG. 3 is a flow diagram illustrating another example method 300 according to various embodiments. Method 300 may be performed by system 100 or any components thereof such as the automated script generator 102, as described above. Depending on the implementation, method 300 may include additional, fewer, or alternative steps performed in various orders or in parallel. Method 300 or any operations thereof may be combined with other methods described herein in any suitable manner.

At 302, a request for access to the automated script generator from a developer (i.e., a requesting developer) is received in the automated script generator. The request may be sent from a server communicatively connected to the automated script generator. At 304, in response to the request for access, an authentication process is performed by the automated script generator to authenticate the developer. The requesting developer may be identified, for example, using developer-specific credentials, such as a username and password. An appropriate authentication method may be employed to verify the developer's identity. Example authentication methods may include username-password authentication, multi-factor authentication (MFA), or single sign-on (SSO). Access to UI is granted to the authenticated developer or upon an indication of an active authentication status of the developer.

At 306, a request for new script is received from the developer by the automated script generator. In some embodiments, the request is submitted through the UI by the developer. The request may include a scripting language type required by the developer. In some embodiments, the request includes a selection of a specific scripting language type by the developer in the UI. The request may further include relevant information provided by the developer such as relevant information about one or more attributes of the new script and its association with the software product. The request may include a description of one or more attributes and characteristics of the desired script. The request may further include input data, data source, specific requirement, and other relevant information regarding the new script. The information may be provided by the developer in the UI.

At 308, in response to the request for new script, standardized module template and/or standardized script template are identified by the automated script generator. In some embodiments, the request for new script and relevant information provided by the developer are analyzed to determine one or more attributes of the new script. One or more standardized module templates having attributes that match the determined attributes of the requested new script are identified and retrieved from the database where the standardized module templates are stored. In some embodiments, a script template having attributes that match the determined attributes of the requested new script are identified and retrieved from the database where the standardized script templates are stored. In some embodiments, when no standardized script template that have matching attributes can be identified in the database, a new standardized script template is composed by the automated script generator. For example, a semantic analysis is performed to determine an intent of the requesting developer. One or more standardized module templates are identified and retrieved from the database. The identified standardized module templates have attributes that match the determined attributes of the requested new script and also align with the intent of the developer. The standardized module templates are combined and merged to form the new standardized script template. The new standardized script template is tailored to meet the unique requirements defined by the developer's intent and requested attributes. The identified standardized module template and/or script templates are selected by the automated script generator.

At 310, the identified standardized module templates and/or the identified standardized script template are configured by the automated script generator. In some embodiments, placeholders or variables within the selected standardized module template and/or script templates are identified. The data from the input provided by the developer is mapped to the placeholders. The placeholders are populated with the data mapped to the placeholders. In some embodiments, configuration of a standardized module template results in a code snippet. In some embodiments, configuration of a standardized script template results in a customized script.

At 312, a new script is generated by the automated script generator. The new script is based on the customized and configured script template created in the previous steps. The new script may be stored in a repository specifically designated for unaudited scripts.

At 314, an audit function is performed on the new script by the automated script generator. The audit function may include conducting a series of tasks including one or more validation tasks and one or more testing tasks on the new script. In some embodiments, a validation task is performed on the new script. During validation, the new script is assessed against predetermined validation rules to check correctness and adherence to standards. For example, a validation rule may specify a naming convention for variable names in the new script. The validation task may be executed to examine all variable names within the new script. During validation, the new script is scanned to check whether each of the variable names follows the naming convention specified in the validation rule. In some embodiments, the script is validated against a predetermined validation rule to determine a level of adherence of the script to the validation rule. A validation score is obtained based on the level of adherence. A determination is made on whether the validation score exceeds a predetermined threshold. If the validation score is at or above the predetermined threshold, a determination is made that the script is validated. If the validation score is below the predetermined threshold, a determination is made that the script is not validated. A validation report may be generated to identify the variable names that are not in compliance with the validation rule.

Once the new script is validated, a testing task is performed on the new script subsequently by the automated script generator. In some embodiments, one or more test environments are created. One or more test configuration profiles may be identified, selected, and retrieved from a database in connection with the automated script generator. The one or more test environments may be configured by executing the selected test configuration profiles. The testing task is then performed on the new script in the configured test environment. During testing, the functional aspects and behavior of the new script are monitored to validate its intended functionality. The new script is executed to check whether the new script performs as expected according to the test scenarios specified in the test configuration file and inputs provided by the developer. The testing may also include normal and edge cases, as well as verifying that the script meets predetermined performance criteria. In some embodiments, a performance outcome score may be generated based on a predetermined rule. In some embodiments, an audit report for the validation and testing may be generated. The audit report may include the results of validation and testing.

As an example, a test environment is created by creating a virtual machine on a cloud. A specified data source, various input values, and test cases are determined and provided by the test configuration profile. An expected performance goal is established, for example, to require that the response time should be less than 100 milliseconds. A predetermined testing rule may specify that “the tested script must return ‘True’ only when the input value is less than or equal to 5. Otherwise, it should return ‘False.’” In an example testing task, the virtual machine is configured with the specified data source, and the input values are prepared according to the test configuration profile. Two test cases are executed. A first test case (i.e., test case 1) is executed with the input value of 5 using the tested script. A determination is made on whether the return of the script is “True.” A second test case (i.e., test case 2) is executed with the input value of 10 using the script. A determination is made on whether the return of the script is “False.” The response time of the script is also measured during the execution of both test cases. A determination is made on whether the response time (i.e., an aspect of performance) is less than 100 milliseconds. If the script passes all test cases and meets the expected performance goal, it is determined to have passed testing. If the script fails any test case or does not meet performance criteria, it is determined that further modification or debugging may be needed.

In some embodiments, a testing task is executed on the script against a predetermined testing rule, which specifies an expected performance outcome from the script. A tested performance outcome is obtained from the script as a result of the testing task. The tested performance outcome and the expected performance outcome are compared to determine whether the tested performance outcome and the expected performance outcome match. In the presence of a match, a determination is made that the script passes the testing. In the absence of a match, a determination is made that the script fails the testing.

In some embodiments, when the newly generated script fails the audit or does not meet the audit criteria, which includes both validation and testing, an iterative modification process or cycle can be initiated by the automated script generator. The modification process is used to refine the script until it successfully passes the audit. In some embodiments, the modification process may include selecting different module templates and replacing the current module templates within the script to alter the composition of the script. Subsequently, a modified script is generated based on these changes. Further validation and testing may be performed on the modified script. This modification cycle continues until the modified script successfully meets the audit requirements.

In some embodiments, the modified script continues to fail the audit, even after several consecutive modification attempts (e.g., a predetermined threshold can specify the maximum number of permitted modification cycles such as three consecutive iterations). If the number of modification cycles exceeds the predetermined threshold, a notification may be generated by the automated script generator and sent to the developer, requesting them to review and potentially amend the input data or provide additional information related to the script.

At 316, access to the new script is provided to the developer by the automated script generator. In some embodiments, the access is provided through the UI of the automated script generator. In some embodiments, the new script is stored in a script repository. In some embodiments, the library/inventory/repository of the module templates or script templates are updated to include the templates used in the generation of the new script.

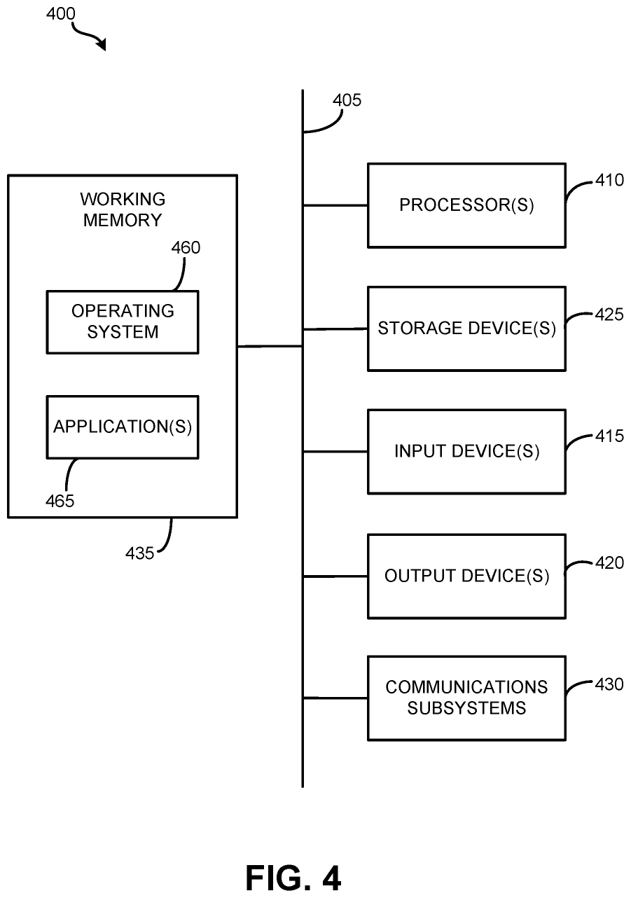

The automated script generator and other components in system 100 described above may include a computer system that further includes computer hardware and software that form special-purpose network circuitry to implement various embodiments such as communication, calculation, navigation service provisioning, and so on. FIG. 4 is a schematic diagram illustrating an example of computer system 400. The computer system 400 is a simplified computer system that can be used to implement various embodiments described and illustrated herein. FIG. 4 provides a schematic illustration of one embodiment of a computer system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g., the first electronic device, may be incorporated into the computer system 400, e.g., an electronic device as an input device 415. In some embodiments, the computer system 400 will further include a working memory 435, which can include a RAM or ROM device, as described above.

The computer system 400 also can include software elements, shown as being currently located within the working memory 435, including an operating system 460, device drivers, executable libraries, and/or other code, such as one or more application programs 465, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 425 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the operations of such methods are performed by the computer system 400 in response to processor 410 executing one or more sequences of one or more instructions, which might be incorporated into the operating system 460 and/or other code, such as an application program 465, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a template” may include a plurality of such templates, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A computer-implemented method performed by an automated script generator in communication with a user, the method comprising:
receiving, in the automated script generator, a request for a script from the user, the request indicating a scripting language type and including input data and information related to the script;
analyzing the information related to the script to determine one or more attributes related to the script;
identifying a standardized script template for the requested script, the standardized script template being stored in a database in connection with the automated script generator and having the requested scripting language type and attributes that match the determined attributes of the script;
configuring the standardized script template with the input data included in the request;
generating a script based on the configuration of the standardized script template; and
executing an audit function on the generated script.

2. The method of claim 1, further comprising:
in response to a determination that the script passes the audit, outputting the script; and
providing access to the script to the user.

3. The method of claim 1, further comprising:
prior to receiving the request for the script, receiving a request for access to the automated script generator sent from the user, the request for access including a user ID and user credential of the user; and
in response to the request for access, authenticating the user based on the user ID and user credential.

4. The method of claim 1, further comprising:
identifying one or more standardized module templates stored in the database, the standardized module template having the requested scripting language type and attributes that match the attributes of the script;
generating a standardized script template by merging the identified one or more standardized module templates; and
storing the standardized script template in the database.

5. The method of claim 1, wherein configuring the standardized script template with the input data further comprises:
identifying one or more placeholders that require configuration within the identified standardized script template;
mapping the input data included in the request to the one or more placeholders; and
populating the one or more placeholders with the input data.

6. The method of claim 1, further comprising:
storing the generated script in a repository before executing an audit function on the script.

7. The method of claim 1, wherein executing the audit function further comprises:
validating the script against a predetermined validation rule to determine a level of adherence of the script to the validation rule;
obtaining a validation score based on the level of adherence; and
in response to a determination that the validation score exceeds a predetermined threshold, determining that the script is validated.

8. The method of claim 1, wherein executing the audit function further comprises:
executing a testing task on the script against a predetermined testing rule, the testing rule specifying an expected performance outcome from the script;
obtaining a tested performance outcome from the script in the testing task;
comparing the tested performance outcome and the expected performance outcome; and
in response to a determination that the tested performance outcome matches the expected performance outcome, determining that the script passes the testing.

9. The method of claim 8, wherein executing the audit function further comprises:
creating a testing environment for the testing task;
identifying a test environment profile in a database in connection with the automated script generator; and
configuring the testing environment with the test environment profile,
wherein the testing task is executed in the test environment.

10. The method of claim 1, further comprising:
in response to a determination that the script fails the audit, automatically initiating a modification cycle, the modification cycle comprising:
generating a modified script; and
executing an additional audit function on the modified script; and
in response to a determination that the modified script fails the audit, initiating an additional modification cycle until a total number of the modification cycles reaches a predetermined number.

11. An automated script generator comprising:
one or more processors; and
a computer-readable storage media storing computer-executable instructions that, when executed by the one or more processors, cause the automated script generator to:
receive, in the automated script generator, a request for a script from a user, the request indicating a scripting language type and including input data and information related to the script;
analyze the information related to the script to determine one or more attributes related to the script;
identify a standardized script template for the requested script, the standardized script template being stored in a database in connection with the automated script generator and having the requested scripting language type and attributes that match the determined attributes of the script;
configure the standardized script template with the input data included in the request;
generate a script based on the configuration of the standardized script template; and
execute an audit function on the generated script.

12. The automated script generator of claim 11, wherein the instructions when executed by the one or more processors further cause the automated script generator to:
output the script in response to a determination that the script passes the audit; and
provide access to the script to the user.

13. The automated script generator of claim 11, wherein the instructions when executed by the one or more processors further cause the automated script generator to:
receive a request for access to the automated script generator sent from the user prior to receiving the request for the script, the request for access including a user ID and user credential of the user; and
authenticate the user based on the user ID and user credential in response to the request for access.

14. The automated script generator of claim 11, wherein the instructions when executed by the one or more processors further cause the automated script generator to:
identify one or more standardized module templates stored in the database, the standardized module template having the requested scripting language type and attributes that match the attributes of the script;
generate a standardized script template by merging the identified one or more standardized module templates; and
store the standardized script template in the database.

15. The automated script generator of claim 11, wherein the instructions when executed by the one or more processors further cause the automated script generator to:
identify one or more placeholders that require configuration within the identified standardized script template;
map the input data included in the request to the one or more placeholders; and
populate the one or more placeholders with the input data.

16. The automated script generator of claim 11, wherein the instructions when executed by the one or more processors further cause the automated script generator to:
store the generated script in a repository before executing the audit function on the script.

17. The automated script generator of claim 11, wherein the instructions when executed by the one or more processors further cause the automated script generator to:
validate the script against a predetermined validation rule to determine a level of adherence of the script to the validation rule;
obtain a validation score based on the level of adherence; and
in response to a determination that the validation score exceeds a predetermined threshold, determine that the script is validated.

18. The automated script generator of claim 11, wherein the instructions when executed by the one or more processors further cause the automated script generator to:
execute a testing task on the script against a predetermined testing rule, the testing rule specifying an expected performance outcome from the script;
obtain a tested performance outcome from the script in the testing task;
compare the tested performance outcome and the expected performance outcome; and
in response to a determination that the tested performance outcome matches the expected performance outcome, determine that the script passes the testing.

19. The automated script generator of claim 18, wherein the instructions when executed by the one or more processors further cause the automated script generator to:
create a testing environment for the testing task;
identify a test environment profile in a database in connection with the automated script generator; and
configure the testing environment with the test environment profile,
wherein the testing task is executed in the test environment.

20. The automated script generator of claim 11, wherein the instructions when executed by the one or more processors further cause the automated script generator to:
in response to a determination that the script fails the audit, automatically initiate a modification cycle, the modification cycle comprising:
generating a modified script; and
executing an additional audit function on the modified script; and
in response to a determination that the modified script fails the audit, initiate an additional modification cycle until a total number of the modification cycles reaches a predetermined number.
